(19) United States
(12) Patent Application Publication
(10) Pub. No.: US 2007/0047185 A1
(43) Pub. Date: Mar. 1, 2007

(54) Keyboard for storing remote controller

(76) Inventors: Shih-Yun Lee, Chungho City (TW); Jung-Wen Chang, Lu Chu Hsiang (TW)

Correspondence Address: RABIN & BERDO, P.C., Suite 500, 1101 14 Street, N.W., Washington, DC, 20005, US

(21) Appl. No.: 11/365,824

(22) Filed: Mar. 2, 2006

(30) Foreign Application Priority Data
Aug. 24, 2005 (TW) 94214551

(51) Int. Cl. G06F 1/16

(52) U.S. Cl. 361/680

(57) ABSTRACT

A keyboard for storing a remote controller, including a pusher that is slidable within a space underneath the keyboard, an elastomer disposed within the space for pressing against one end of the pusher, a controller shaped to match contours of the space and having a tongue provided thereon, and a hook disposed within the space for detachably connecting to the tongue, whereby the hook is selectively connected to or separated from the tongue via the elastomer and the pusher when the controller is completely inserted into or ejected out of the space.

### RELATED APPLICATIONS

The present application is based on, and claims priority from, Taiwan Application Serial Number 94214551, filed Aug. 24, 2005, the disclosure of which is hereby incorporated by reference herein in its entirety.

### BACKGROUND

1. Field of Invention

The present invention relates to computer peripherals. More particularly, the present invention relates to a keyboard for storing a remote controller.

2. Description of Related Art

With the rapid development of various technologies, the computer offers more than just word processing and video playing capability. It also offers various multimedia applications, such as TV reception, real-time video processing and web-phone communication, providing consumers with more convenience and cost savings.

Wireless keyboards and mice have been widely used by users to control computers easily. Controllers are available on the market that can be separated from or combined with a keyboard such that a user can remotely control a computer, but these keyboards require an additional space to accommodate the controller and thus undesirably increase in size.

Therefore, it would be advantageous to provide a novel keyboard that offers compact and more convenient storage of the controller.

### SUMMARY

It is therefore an objective of the present invention to provide a keyboard in which one or several digital remote controllers can be easily stored without occupying excessive space.

In one aspect of the present invention, the keyboard comprises a pusher that slides within a space underneath the keyboard, an elastomer disposed within the space for pressing against one end of the pusher, a controller shaped to match contours of the space and having a tongue formed on a bottom thereof, and a hook disposed within the space for detachably connecting to the tongue, whereby the hook is selectively connected to or separated from the tongue via the elastomer and the pusher when the controller is completely inserted in or ejected out of the space.

In another aspect of the present invention, the keyboard comprises a pusher that slides within a space underneath the keyboard, in which the pusher has a sliding trench, a leading rod provided at one end of the sliding trench, an elastomer longer than the leading rod and engaging over leading rod, a controller shaped to match contours of the space and having a tongue formed on a bottom thereof, at least one sliding track provided on the bottom of the keyboard and shaped to match contours of the sliding trench thereby allowing the pusher to move back and forth along the sliding track, a leading rod tongue provided on the bottom of the keyboard for storing the leading rod of the pusher therein, and a hook detachably connecting to the tongue, wherein the hook is selectively connected to or separated from the tongue via the elastomer and the pusher when the controller is completely inserted in or ejected out of the space, providing a keyboard which is compact and easily stores the controller.

Other aspects and advantages of the invention are more fully apparent from the ensuing disclosure, appended claims and drawings.

### BRIEF DESCRIPTION OF THE DRAWINGS

These and other features, aspects and advantages of the present invention become better understood with regard to the following description, appended claims and accompanying drawings, where:

FIG. 1 is a schematic front view of a keyboard for storing a remote controller in accordance with one embodiment of the present invention;

FIG. 2 is a perspective rear view of the keyboard shown in FIG. 1, which shows the controller being separated from the keyboard;

FIG. 3 is a perspective rear view of the keyboard shown in FIG. 1, which shows the controller being completely inserted into the keyboard; and

FIG. 4 is a cross-sectional side view of the keyboard taken along line 2-2 of FIG. 3.

### DESCRIPTION OF THE PREFERRED EMBODIMENTS

Reference is now made in detail to the present preferred embodiments of the invention, examples of which are illustrated in the accompanying drawings. Wherever possible, the same reference numbers are used in the drawings and the description to refer to the same or like parts.

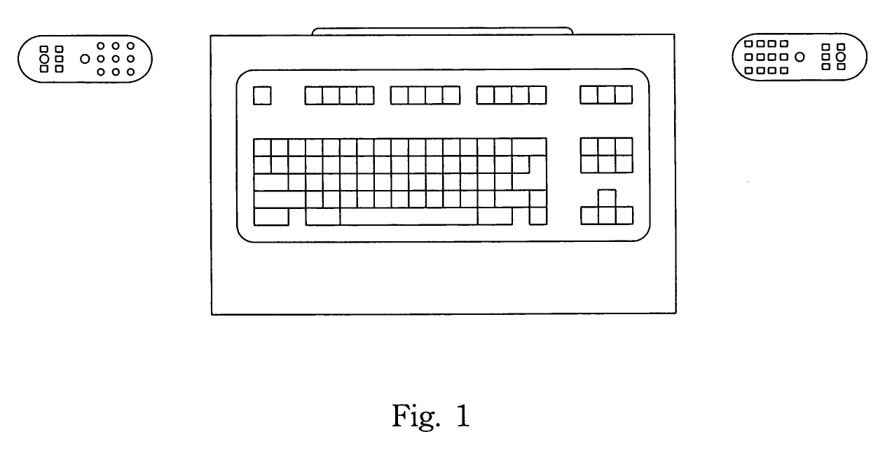

FIG. 1 shows a schematic front view of a keyboard for storing a remote controller in accordance with one embodiment of the present invention. FIG. 1 illustrates an aspect of a keyboard having a digital controller and a phone controller ejected from sides of the keyboard, respectively. It should be noted that the structural features of the keyboard described herein can be applied to any kind of keyboard (for example, portable computer or desktop computer) or can be installed on the bottom of a general keyboard. Thus, embodiments of the present invention are not limited to a specific keyboard portrayed in FIG. 1. The illustrated digital controller and phone controller shown in FIG. 1 are hereinafter referred to as “controller” only.

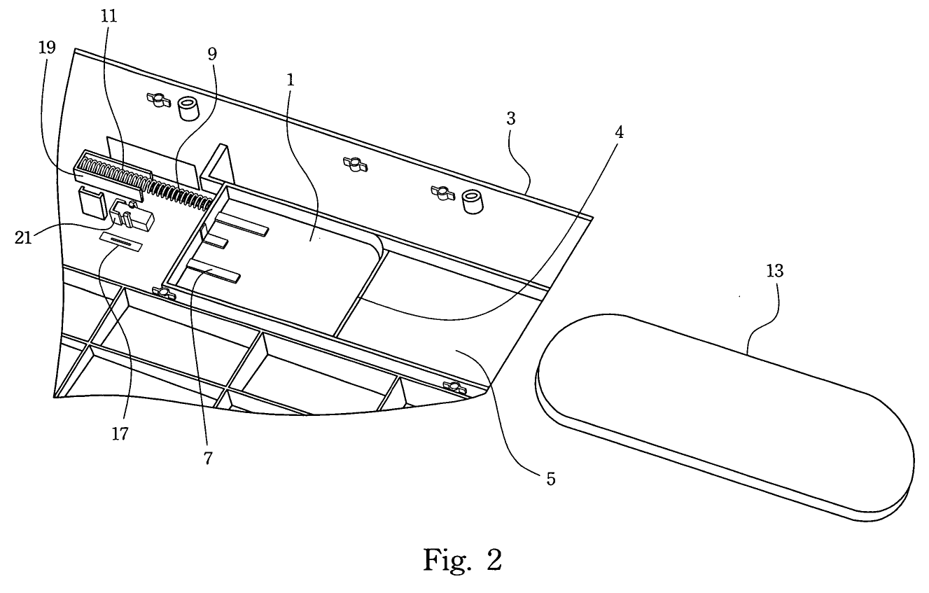

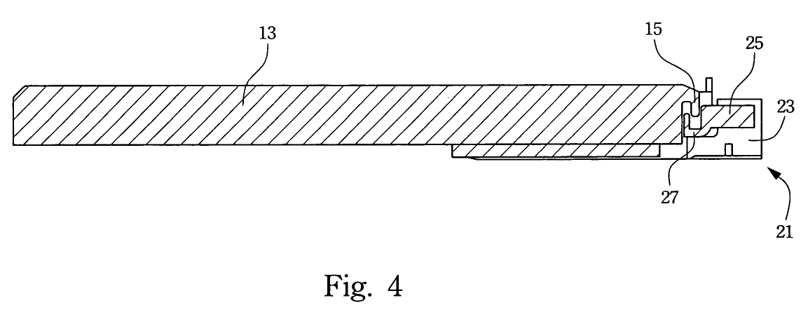

FIG. 2 is a perspective rear view of the keyboard shown in FIG. 1, which shows the controller being separated from the keyboard. The keyboard for storing a controller comprises: a pusher 1 that is slidable within a space 5 underneath the keyboard 3, in which the pusher 1 has a sliding trench 7; a leading rod 9 provided at one end of the pusher 2; an elastomer 11 that is longer than the leading rod 9 and engages over the leading rod 9; a controller 13 shaped to match the contour of the space 5 and having a tongue 15 on a bottom thereof (shown in FIG. 4); at least one sliding track 17 provided on the bottom of the keyboard 3 and shaped to match the contour of the sliding trench 7 thereby allowing the pusher 1 to move back and forth along the sliding track 17; a leading rod recess 19 provided on the bottom of the keyboard 3 for storing the leading rod 9 of the pusher 1 therein; and a hook 21 detachably connecting to the tongue 15, wherein the hook 21 can be selectively connected to or separated from the tongue 15 via the elastomer and the pusher 1 when the controller 13 is completely inserted in or ejected out of the space 5.

In the embodiments of the present invention, the term “space 5” refers to the area located between a block 4 and the hook 21 beneath the keyboard 3.

In one embodiment of the present invention shown in FIG. 2, the pusher 1 is substantially a rectangular case into which the controller 13 can be inserted from one side thereof. The shape of the pusher 1 described herein is not limited to being rectangular. Rather, any design that may be pushed and arranged within the space 5 at the bottom of the keyboard should be applied, so long as the controller 13, when moving inwardly, is effective in pushing against the elastomer 11. The underside of the illustrated rectangular pusher 1 has at least one sliding trench 7, the size and length of which is suitable for storing the sliding track 17 arranged on the bottom of the keyboard, thereby allowing the pusher 1 to move back and forth along the sliding track 17. Alternatively, the sliding track 17 or trench can be omitted if the pusher 1 and the space 5 of the keyboard 3 are structurally matched to each other.

In an embodiment of the present invention, the pusher 1 has a leading rod 9 at one end, which is placed within a leading rod recess 19. The leading rod 9 is encompassed by an elastomer 11 that is longer than the leading rod 9. The elastomer 11 shown in FIG. 2 is a compression spring. The leading rod recess 19 has substantially the same length as the leading rod 9, whereas the length of the compression spring is longer than that of the leading rod 9 so that the leading rod 9 directs the spring and prevents it from buckling. The spring length is preferably longer than the leading rod 9 so that it can be fully compressed as the pusher 1 engages with the hook 21 (described below). Conversely, the tension released from the spring ejects the controller 13 out of the pusher 1 as it is separated from the hook 21.

According to the present invention, the sliding trench 7 or sliding track 17 may be omitted if the space 5 underneath the keyboard 3 has a suitable structure for the pusher 1 to be easily moved therein, so long as the controller 13 is detachably connected with the hook 21. In one aspect, the leading rod 9 could act as a pusher by itself without having such a rectangular case.

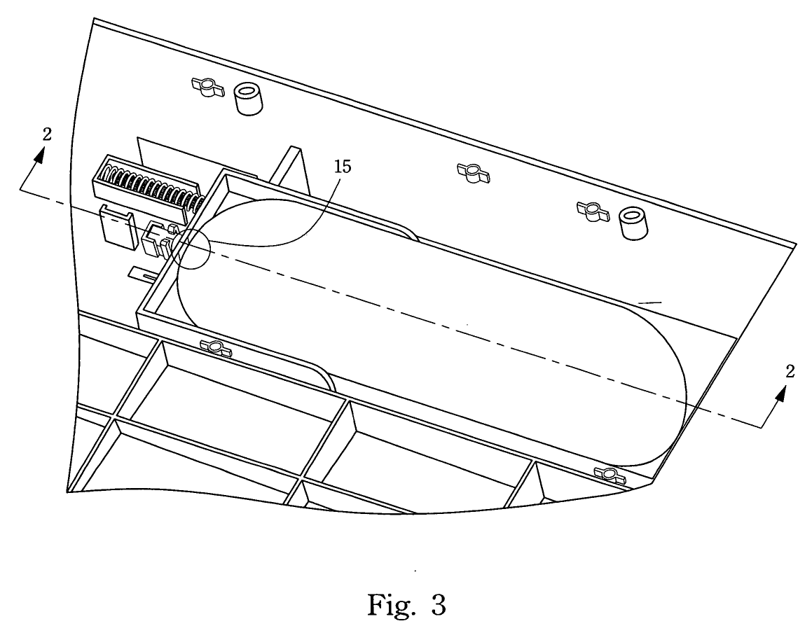

In an embodiment of the present invention, the keyboard is provided with controllers 13 on its left and right sides. The size and shape of each controller 13 is suitable for the space 5 underneath the keyboard 3. The bottom of each controller 13 has a tongue 15 (shown in FIG. 3), which matches the hook 21 provided on the space underneath the keyboard 3. The hook mechanism, i.e., the hook 21 and the tongue 15, is a conventional push type connector or so-called “Push-Push Function” connector.

FIG. 3 is a perspective rear view of the keyboard shown in FIG. 1, which shows the controller being completely inserted into the keyboard. FIG. 4 is a cross-sectional side view of the keyboard taken along line 2-2 of FIG. 3. FIG. 4 shows the relative position of the pusher 1, controller 13, hook 21 and tongue 15 as they connect to each other. The hook 21 includes a sloping base 23, and a block 25 extending from a curved surface of the sloping base 23 as well as a clasp 27 which is curved at one end to comply with the curved surface. When the user stores the controller 13, he or she simply pushes the controller 13 into the keyboard to connect the tongue 15 (on the bottom of the controller) with the clasp 27 of the hook 21. When pushing to eject the controller 13, one surface of the tongue 15 underneath the controller 13 pushes one end of the clasp 27 such that the other end moves upwardly along the curved surface of the sloping base 23, thereby separating the tongue 15 from the clasp 27. Once the hook 21 is separated from the tongue 15, the elastomer, such as the compression spring (not shown) that is compressed at one end of the pusher 1, is released and forces the controller 13 to eject out of the keyboard.

The hook mechanism of the present invention is a conventional connector, thus modifications to the above disclosed connector operation should be readily apparent to those of ordinary skill in the art. For instance, the elastomer 11 may be replaced by a flat spring.

In an embodiment of the present invention, the controller 13 provides not only the basic functions for controlling the computer, but also at least one controlling module, telephone interface and emitter for serving as a VoIP (voice over IP) phone. The keyboard 3 is also provided with a receiver for receiving signals or instructions from the emitter of the controller 13. The keyboard 3 is further provided with a communication module, signal receiving/transmitting interface and digital signal converter for facilitating communication with the telephone interface in the controller 13. Alternatively, the controller 13 may be interacted with communication software in a computer via the keyboard line so that the controller 13 is an interface to be used in a general VoIP phone. Due to a low cost, more convenience and better quality of the VoIP phone, the controller 13 of the present invention may serve as a controlling device combining remote control and telephone functions, which is also compact and elegant after it is inserted into the keyboard 3.

It will be apparent to those skilled in the art that various modifications and variations can be made to the structure of the present invention without departing from the scope or spirit of the invention. For example, the controller may also include a memory module to store data from the computer. Accordingly, while the present invention has been disclosed with specific embodiments thereof, it should be understood that other embodiments may fall within the spirit and scope of the invention, as defined by the following claims.

What is claimed is:

1. A keyboard for storing a controller, comprising:
a pusher that is slidable within a space underneath the keyboard;
an elastomer disposed within the space for pressing against one end of the pusher;
a controller shaped to match contours of the space and having a tongue formed on a bottom thereof; and
a hook disposed within the space for detachably connecting to the tongue,
whereby the hook is selectively connected to or separated from the tongue via the elastomer and the pusher when the controller is completely inserted into or ejected out of the space.

2. The keyboard as claimed in claim 1, wherein the space is defined by a block located underneath the keyboard.

3. The keyboard as claimed in claim 1, wherein the pusher is further formed with at least one sliding trench.

4. The keyboard as claimed in claim 1, wherein the bottom of the keyboard further comprises at least one sliding track shaped to match contours of the sliding trench, thereby allowing the pusher to move back and forth along the sliding track.

5. The keyboard as claimed in claim 1, wherein the controller comprises at least one controlling module, a telephone interface and an emitter.

6. The keyboard as claimed in claim 5, further comprising a receiver for receiving signals or instructions from the emitter of the controller.

7. The keyboard as claimed in claim 5, further comprising a communication module, a signal receiving/transmitting interface and a digital signal converter, for facilitating communication with the telephone interface in the controller.

8. The keyboard as claimed in claim 1, wherein the elastomer is a compression spring.

9. The keyboard as claimed in claim 8, wherein the pusher comprises a rod disposed within the compression spring.

10. The keyboard as claimed in claim 8, wherein the pusher is substantially a rectangular case into which the controller is inserted from one side thereof.

11. The keyboard as claimed in claim 1, wherein the elastomer is a flat spring.

12. A keyboard for storing a controller, comprising:
a pusher that is slidable within a space underneath the keyboard, in which the pusher has a sliding trench;
a leading rod provided at one end of the pusher;
an elastomer that is longer than the leading rod and engages over the leading rod;
a controller shaped to match contours of the space and having a tongue formed on a bottom thereof;
at least one sliding track provided on the bottom of the keyboard and shaped to match contours of the sliding trench, thereby allowing the pusher to move back and forth along the sliding track;
a leading rod recess provided on the bottom of the keyboard for storing the leading rod of the pusher therein; and
a hook detachably connecting to the tongue, wherein the hook is selectively connected to or separated from the tongue via the elastomer and the pusher when the controller is completely inserted into or ejected out of the space.

13. The keyboard as claimed in claim 12, wherein the space is defined between a block and a hook underneath the keyboard.

14. The keyboard as claimed in claim 12, wherein the controller comprises at least one controlling module, a telephone interface and an emitter.

15. The keyboard as claimed in claim 14, further comprising a receiver for receiving signals or instructions from the emitter of the controller.

16. The keyboard as claimed in claim 14, further comprising a communication module, a signal receiving/transmitting interface and a digital signal converter, for facilitating communication with the telephone interface in the controller.

17. The keyboard as claimed in claim 12, wherein the elastomer is a compression spring.

18. The keyboard as claimed in claim 12, wherein the elastomer is a flat spring.
